(19) United States
(12) Patent Application Publication
(10) Pub. No.: US 2003/0197592 A1
(43) Pub. Date: Oct. 23, 2003

(54) Operation control means of a machine, a vehicle or a plant

(76) Inventors: Thomas Mokler, Leingarten (DE); Alwin Ehrensperger, Heilbronn (DE)

Correspondence Address: WALTER A. HACKLER, Ph.D., PATENT LAW OFFICES, SUITE B, 2372 S.E. BRISTOL, NEWPORT BEACH, CA, 92660-0755, US

(21) Appl. No.: 10/412,033

(22) Filed: Apr. 10, 2003

(30) Foreign Application Priority Data
Apr. 13, 2002 (EP) 02 008 446.3

(51) Int. Cl. H04Q 1/00

(52) U.S. Cl. 340/5.31

(57) ABSTRACT

Operation control means of a machine, a vehicle or a plant. An operation control means of a machine, a vehicle or a plant comprises a transmitter-receiver means (1) which is mounted to or in the operating element (2) and a mobile transponder (4) to be permanently worn by the operator. The operation of the machine is controlled, i.e. inadvertent actuation of the operating element (2) is prevented.

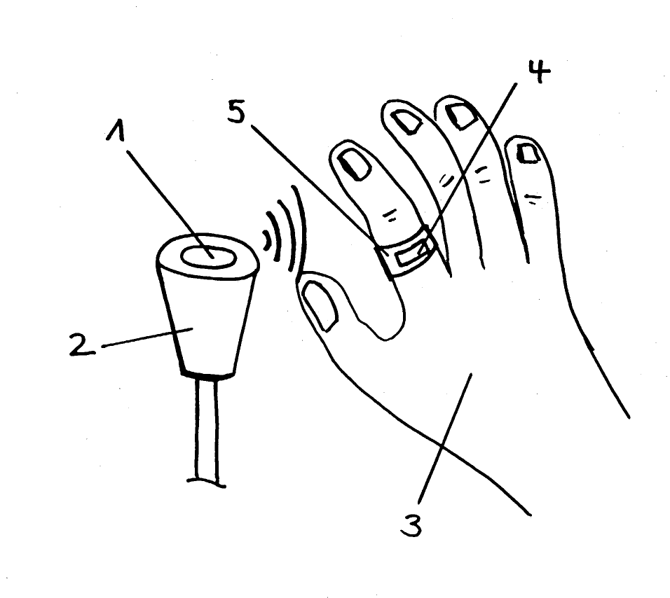

### DESCRIPTION

The invention concerns operation of a machine (excavator, fork lift truck, crane, etc.) of a vehicle or a plant by means of an operating element, e.g. a handle or a joystick or a pedal.

Access control means for vehicles comprising a transmitter-receiver means and a mobile transponder are known. Access control means of this type usually only prevent opening of a vehicle by an unauthorized person.

Machines pose the problem that access control is not absolutely necessary, but control of operation of the machine, i.e. inadvertent operation of the operating element must be prevented. Inadvertent operation has been hitherto controlled through so-called dead man's means.

To solve this problem, the applicant proposes an operation control means comprising a transmitter-receiver means which is mounted to or in the operating element, and comprising a mobile transponder which can be permanently carried by the operator. Application of the transponder technology is directly integrated in the operating elements such as joysticks or handles of machines. The limited range of radio transmission to the transponder ensures that the object triggering operation (e.g. a hand) in the vicinity of which the transponder is positioned, directly causes the desired operation and is not caused in an undesired fashion through other objects without transponder. The user is necessarily continuously identified through permanent signal exchange (dialogue) between transmitter—receiver—means and transponder, and intention and authorization are checked.

The system can be designed such that different transponders which are used by different operators with simultaneous authorization, transmit different authorizing codes. This permits differentiation of different authorized operators through the code.

The settings can be automatically established or changed depending on the operator. The parameters of the machine can be requested in a predetermined fashion in dependence on the operator.

The invention provides advantages with regard to transmission safety and absolutely reliable prevention of abuse and inadvertent operation.

A preferred embodiment is described below by means of the drawing.

The FIGURE shows schematically the cooperation between a transmitter-receiver means 1 which is integrated in a handle 2 for operating a machine (not shown). The transmitter-receiver means 1 has a low weight and requires little space, and is integrated in the housing of the handle 2 and consists substantially of electronics, an antenna and power supply. The electronics comprises structural elements for changing, preparing and transmitting/receiving radio signals.

To operate the machine and/or perform control commands, the handle 2 can be operated manually 3 by the operator. Analogously, also a pedal could be actuated by a foot.

The handle 2 is provided with the transmitter-receiver means 1 which can provide radio waves for activating and supplying a transponder 4 and process transmitted codes. The mobile transponder 4 is carried on the body of the operator. The transponder 4 is integrated in a ring 5. As an alternative to the ring, also a watch, a bracelet, a unit implanted under the skin, a piece of clothes, e.g. a glove or the like could be used. It is housed in a fashion protected from impacts and spray water. The transmitter-receiver unit 1 of the machine and the mobile transponder 4 of the operator form together an operation control means. Signals transmitted from the transmitter-receiver means 1 are received and processed by the transponder 4 and returned to the transmitter-receiver means 1. The transponder 4 is designed such that it returns a code upon radiation with certain radio waves, which permit identification of its user. The handle 2 reacts only to control commands of the operator when an admissible code is successfully and permanently received. For this reason, only the authorized operator can operate the machine. This ensures that the handle can be actuated only as intended.

The transponder 4 is housed in the ring 5 which is carried by the operator. The handle 2 can be actuated only when the correct hand (i.e. the one with the ring 5) of the operator grasps around the handle. Inadvertent actuation through an elbow or knee during getting in is reliably prevented.

List of Reference Numerals

1 transmitter-receiver means

2 handle

3 hand of operator

4 transponder

5 ring

1. Operation control means of a machine, a vehicle or a plant comprising a transmitter-receiver means (1) which is mounted to or in the operating element (2), and a mobile transponder (4) to be permanently carried by the operator.

2. Operation control means, characterized in that the transponder (4) is integrated in a piece of clothing (5).

3. Operation control means according to claim 2, characterized in that the piece of clothing is a ring (5), a watch, a bracelet, a glove or the like.

4. Operation control means according to claim 1, characterized in that the transponder can be implanted under the skin of the user.

5. Operation control means according to any one of the preceding claims, characterized in that operation authorization related to a user can be automatically requested and set.
